(19) United States
(12) Patent Application Publication
(10) Pub. No.: US 2014/0306932 A1
(43) Pub. Date: Oct. 16, 2014

(54) ELECTRONIC WHITEBOARD

(71) Applicant: HON HAI PRECISION INDUSTRY CO., LTD., New Taipei (TW)

(72) Inventor: YUNG-CHANG TSENG, New Taipei (TW)

(73) Assignee: HON HAI PRECISION INDUSTRY CO., LTD., New Taipei (TW)

(21) Appl. No.: 14/051,466

(22) Filed: Oct. 11, 2013

(30) Foreign Application Priority Data
Apr. 12, 2013 (TW) 102112948

(51) Int. Cl. G06F 3/03

(52) U.S. Cl. CPC G06F 3/0325
USPC 345/175

(57) ABSTRACT

An electronic whiteboard includes a frame comprising inner sides, an electronic paper stretched and connected to the inner sides of the frame, a number of infrared emitters positioned on the inner sides of the frame, a number of infrared receivers positioned on the inner sides of the frame, and a driver in communication with the infrared receivers and the electronic paper. Infrared light beams emitted from the infrared emitters interweave as a grid that is substantially parallel with and covers the electronic paper. Each infrared receiver receives the infrared light beam from one of the infrared emitters to detect if an object is inserted into the grid and blocks the infrared light beam to detect positions and thus a trajectory of the object in the grid. The controller drives the electronic paper to display a writing corresponding to the trajectory in shape and position.

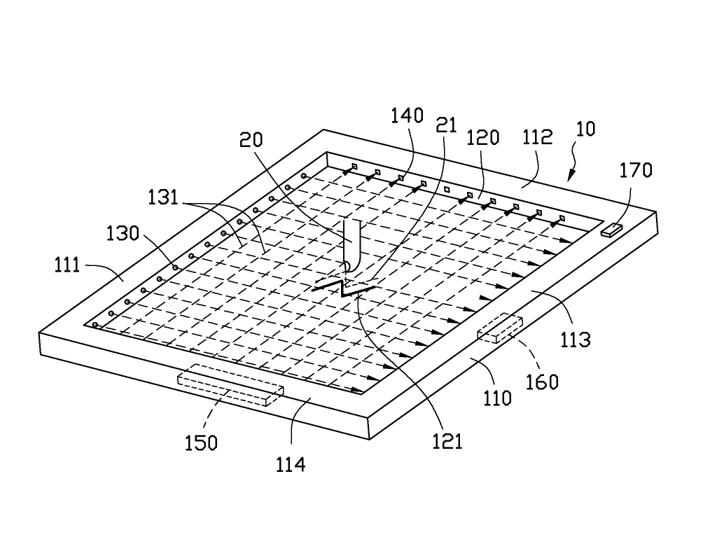

### BACKGROUND

1. Technical Field

The present disclosure relates to whiteboards, and particularly to an electronic whiteboard.

2. Description of Related Art

At present, whiteboards are typically written on using ink pens. As such, the ink pen needs to be prepared in advance, which is inconvenient. In addition, the ink pen consumes ink, which increases cost and may cause contamination.

Therefore, it is desirable to provide an electronic whiteboard that can overcome the above-mentioned problems.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the present disclosure.

The drawing is an isometric, schematic view of an electronic whiteboard in accordance with an embodiment.

### DETAILED DESCRIPTION

Embodiments of the present disclosure will be described with reference to the drawing.

The drawing shows an electronic whiteboard 10, according to an embodiment. The whiteboard 10 includes a frame 110, an electronic paper 120 stretched and connected to inner sides of the frame 110, a number of infrared emitters 130 positioned on the inner sides of the frame 110, a number of infrared receivers 140 positioned on the inner sides of the frame 110, and a driver 150 in communication with the infrared receivers 140 and the electronic paper 120. Infrared light beams 131 emitted from the infrared emitters 130 interweave as a grid that is substantially parallel with and covers the electronic paper 120. Each infrared receiver 140 receives the infrared light beam 131 from one of the infrared emitters 130 to detect if an object 20 is inserted into the grid and blocks the infrared light beam 131. As such, positions and thus a trajectory 21 of the object 20 in the grid can be detected. The driver 150 drives the electronic paper 120 to display a writing 121 corresponding to the trajectory 21 in shape and position.

As such, the electronic whiteboard 10 can be written on by the object 20 which can be anything convenient for users, such as fingers. In addition, writing on the electronic whiteboard 10 does not consume anything or cause any contamination.

The frame 110 is substantially rectangular in this embodiment but can take other suitable forms in other embodiments. The frame 110 includes a first side 111, a second side 112, a third side 113, and a fourth side 114. The first side 113 is substantially parallel with the third side 113 and connected between one end of the second side 112 and one end of the fourth side 114, which are also substantially parallel with each other. The third side 113 is connected between another end of the second side 112 and another end of the fourth side 114.

The electronic paper 120 is also substantially rectangular and can employ a cholesteric liquid crystal display, an electrophoretic display, or an electrowetting display. The electronic paper 120 can be a monochromatic display (white-black) or a color display, depending on need.

The electronic whiteboard 10 includes a power source 160. The electronic paper 120 is powered by the power source 160. The electronic paper 120 is a bistable display, that is, the electronic paper 120 can maintain an originally displayed image after the power source 160 is cut off. As such, the driver 150 cuts off the power source 160 from the electronic paper 120 when nothing is detected by the infrared receivers 140 and connects the power source 160 to the electronic paper 120 when the object 20 is detected by the infrared receivers 140. As such, a power consumption of the electronic whiteboard 10 can be reduced to further reduce cost.

The infrared emitters 130 are infrared laser diodes. As such, detecting accuracy can be enhanced due to an excellent directionality of the infrared laser diodes. The infrared emitters 130 are positioned on the first side 111 and the fourth side 114. The infrared emitters 130 are linearly and equal-distantly arranged. The number of the infrared emitters 130 is balanced by the requirement of detecting accuracy and cost. The more the emitters 130, the higher the accuracy and cost.

The infrared receivers 140 are infrared photo diodes and positioned on the second side 112 and the third side 113. Each infrared receiver 140 is aligned with one of the infrared emitters 130, increasing light use efficiency.

The driver 150 is received in the frame 110.

The electronic whiteboard 10 includes an eraser button 170 which is in communication with the driver 150. The driver 150 drives the electronic paper 120 to display a blank screen when the eraser button 170 is depressed to simulate an erasing action of conventional whiteboard.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. An electronic whiteboard, comprising:
a frame comprising inner sides;
an electronic paper stretched and connected to the inner sides of the frame;
a plurality of infrared emitters positioned on the inner sides of the frame;
a plurality of infrared receivers positioned on the inner sides of the frame; and
a driver in communication with the infrared receivers and the electronic paper;
wherein infrared light beams emitted from the infrared emitters interweave as a grid that is substantially parallel with and covers the electronic paper, each infrared receiver receives the infrared light beam from a respective one of the infrared emitters to detect if an object inserts into the grid and blocks the infrared light beam to detect positions and thus a trajectory of the object in the grid, and the controller drives the electronic paper to display a writing corresponding to the trajectory in shape and position.

2. The electronic whiteboard of claim 1, wherein the frame is substantially rectangular and comprises a first side, a second side, a third side, and a fourth side, the first side is substantially parallel with the third side and connected between one end of the second side and one end of the fourth side, which are also substantially parallel with each other, the third side is connected between another end of the second side and another end of the fourth side, the infrared emitters are positioned on the first side and the fourth side, and the infrared receivers are positioned on the second side and the third side.

3. The electronic whiteboard of claim 1, wherein the electronic paper is selected from the group consisting of a cholesteric liquid crystal display, an electrophoretic display, and an electrowetting display.

4. The electronic whiteboard of claim 1, wherein the electronic paper is selected from the group consisting of a monochromatic display and a color display.

5. The electronic whiteboard of claim 1, wherein the electronic whiteboard comprises a power source, the electronic paper is powered by the power source, the electronic paper is a bistable display, and the driver cuts off the power source from the electronic paper when nothing is detected by the infrared receivers and connects the power source to the electronic paper when the object is detected by the infrared receivers.

6. The electronic whiteboard of claim 1, wherein the infrared emitters are infrared laser diodes.

7. The electronic whiteboard of claim 1, wherein the infrared emitters are infrared photo diodes.

8. The electronic whiteboard of claim 1, wherein the infrared emitters are linearly and equal-distantly arranged, and each infrared receiver is aligned with the corresponding infrared emitter.

9. The electronic whiteboard of claim 1, further comprising an eraser button which is in communication with the driver, the driver being configured for driving the electronic paper to display a blank screen when the eraser button is depressed.
